(19) United States
(12) Patent Application Publication
(10) Pub. No.: US 2006/0074997 A1
(43) Pub. Date: Apr. 6, 2006

(54) Prefix-indexed word-input aiding method and system

(75) Inventors: Chaucer Chiu, Taipei (TW); Anthony Zhou, Taipei (TW)

Correspondence Address: EDWARDS & ANGELL, LLP, P.O. BOX 55874, BOSTON, MA, 02205, US

(73) Assignee: Inventec Corporation

(21) Appl. No.: 10/996,777

(22) Filed: Nov. 23, 2004

(30) Foreign Application Priority Data
Sep. 29, 2004 (TW) 093129377

(51) Int. Cl. G06F 17/30

(52) U.S. Cl. 707/201

(57) ABSTRACT

A prefix-indexed word-input aiding method and system is proposed, which is designed for use in conjunction with an electronic data processing unit for providing the user with a prefix-indexed word-input aiding function that can aid the user in the input of words of a certain phonetic language, such as English, into the electronic data processing unit. The proposed prefix-indexed word-input aiding method and system is characterized in that the user needs just to input the prefix part of a certain word, and a list of prefix-matched words will be popped out on screen for the user to select his/her desired word as the input word. This feature can help the user to create text-based electronic documents more quickly and efficiently.

### BACKGROUND OF THE INVENTION

1. Field of the Invention

This invention relates to information technology (IT), and more particularly, to a prefix-indexed word-input aiding method and system, which is designed for use in conjunction with an electronic data processing unit, such as a desktop computer, a notebook computer, a tablet computer, a network workstation, or the like, for providing the user with a prefix-indexed word-input aiding function that can aid the user in the input of words of a certain phonetic language, such as English, German, French, Spanish, and others, into the electronic data processing unit more efficiently.

2. Description of Related Art

Word processor is a popular and widely-used application on various PC (Personal Computer) platforms such as desktop computers, notebook computers, tablet computers, network workstations, and the like, that allows the user to create a text-based electronic document by inputting the words of any various languages, such as English, French, German, Spanish, Chinese, Japanese, Koreans, and others, into the PC.

In the age of globalization, English is the most important and frequently used language in the world. For this sake, even in non-English-speaking countries it is an important task for users of word processors to use English to create documents. One problem in the input of English words to a PC, however, is that the user may forget the correct spelling of certain words, particularly those lengthy words.

One solution to the foregoing problem is to let the user try to input the English word as complete as he/she can remember and then use a spell checking program to check whether the input word is correctly spelled; and if not, the spell checking program can typically offer a list of possibly-correct words for the user to select his/her wanted word. One drawback to this solution, however, is that the procedure of spell checking is quite time-consuming and thus would significantly make the input work slow and inefficient.

### SUMMARY OF THE INVENTION

It is therefore an objective of this invention to provide a prefix-indexed word-input aiding method and system which can help the user to input words of a phonetic language more efficiently with the help of the prefix of the word.

The prefix-indexed word-input aiding method and system according to the invention is designed for use in conjunction with an electronic data processing unit, such as a desktop computer, a notebook computer, a tablet computer, a network workstation, or the like, for providing the user with a prefix-indexed word-input aiding function that allows the user to more efficiently input words of a phonetic language, such as English, German, French, Spanish, and others, into the electronic data processing unit.

The prefix-indexed word-input aiding method and system according to the invention is characterized by that the user needs just to input the prefix part of a certain word, and the invention will provides a list of all prefix-matched words on screen for the user to select his/her desired word as the input word. This feature can help the user to create text-based electronic documents more quickly and efficiently.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the application architecture and object-oriented component model of the prefix-indexed word-input aiding system according to the invention;

FIG. 2A is a schematic diagram showing an example of a screen display of a prefix-matched word list in response to a user-input text string of a certain prefix by the prefix-indexed word-input aiding system of the invention; and

FIG. 2B is a schematic diagram showing the same prefix-matched word list of FIG. 2A except that the words therein have been reordered according to statistics of user-selections.

### DETAILED DESCRIPTION OF PREFERRED EMBODIMENTS

The prefix-indexed word-input aiding method and system according to the invention is disclosed in full details by way of preferred embodiments in the following with reference to the accompanying drawings.

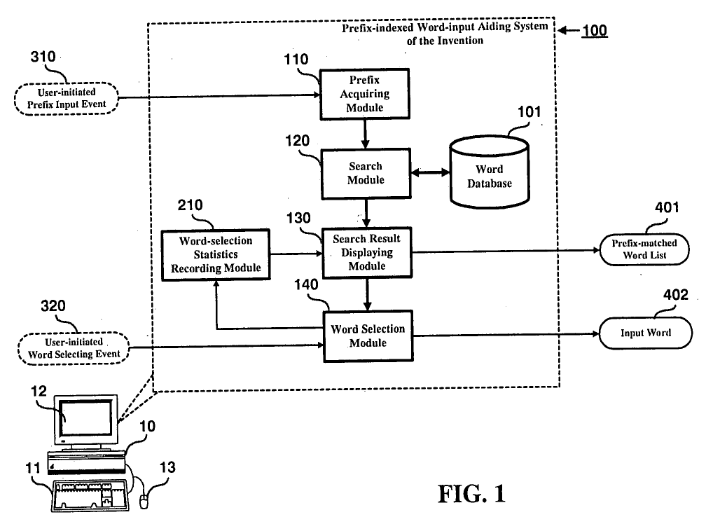

FIG. 1 is a schematic diagram showing the application architecture and object-oriented component model of the prefix-indexed word-input aiding system according to the invention (as the part enclosed in the dotted box indicated by the reference numeral 100). As shown, the prefix-indexed word-input aiding system of the invention 100 is designed for use with in conjunction with an electronic data processing unit 10, such as a desktop computer, a notebook computer, a tablet computer, a network workstation, or the like, for providing a prefix-indexed word-input aiding function that can aid the user in the input of words of a certain phonetic language, such as English, German, French, Spanish, and others, into the electronic data processing unit 10.

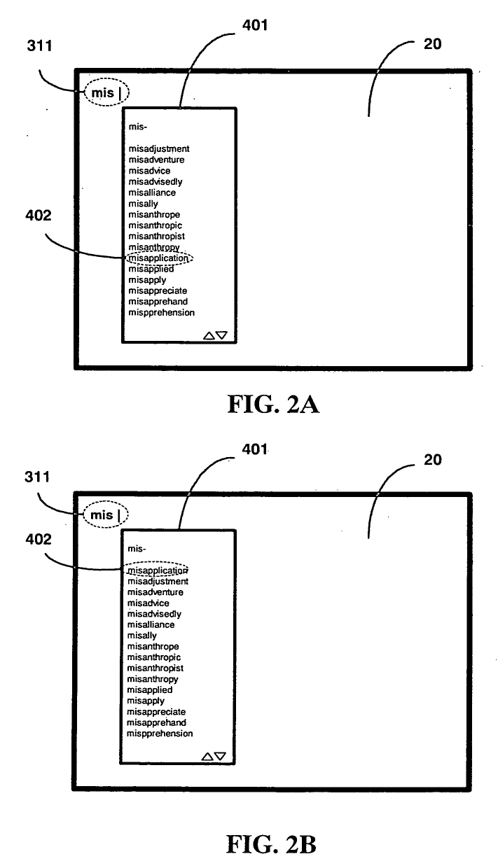

For example, as shown in FIG. 2A, when the user utilizes a word-input window 20 on the electronic data processing unit 10 to create a text-based electronic document, and it is assumed that the user wants to input the English word [misapplication], then the user needs just to input a leading part of the English word, for example the prefix [mis] 311 of the intended English word [misapplication] to the electronic data processing unit 10, and the prefix-indexed word-input aiding system of the invention 100 will respond by displaying a prefix-matched word list 401 on the screen 12 that shows every word in a selected vocabulary set of English whose prefix is matched to the user-input prefix [mis] 311. The user then needs just to select his/her wanted word [misapplication] 402 from the prefix-matched word list 401, and the prefix-indexed word-input aiding system of the invention 100 will take the user-selected word [misapplication] 402 as an input word to the electronic data processing unit 10.

In practical implementation, the prefix-indexed word-input aiding system of the invention 100 can be fully realized by software and integrated as an add-on module to a word processor or any text-intensive applications that are installed on the electronic data processing unit 10.

As shown in FIG. 1, the object-oriented component model of the prefix-indexed word-input aiding system of the invention 100 comprises: (a) a word database 101; (b) a prefix acquiring module 110; (c) a search module 120; (d) a search result displaying module 130; and (e) a word selection module 140; and can further optionally comprise a word-selection statistics recording module 210.

The word database 101 is used to prestore all the words of a selected vocabulary set of a particular phonetic language, such as English. In various other embodiments, the language can also be German, French, Spanish, and others.

The prefix acquiring module 110 is capable of responding to a user-initiated prefix-input event 310 that inputs a text string for a leading part, such as the prefix, of a certain word to the electronic data processing unit (such as the use utilizes the keyboard 11 to input a prefix [mis] 311 shown in FIG. 2A and then press a certain key combination on the keyboard 11) by acquiring the user-input prefix as a keyword and then issuing a search enabling message to the search module 120.

The search module 120 is capable of responding to the search enabling message from the prefix acquiring module 110 by performing a search procedure on the word database 101, in which the user-input prefix acquired by the prefix acquiring module 110 is used a keyword to search through the word database 101 for every word in the word database 101 whose prefix is matched to the user-input prefix. If the search result is null (i.e., no prefix-matched words are found in the word database 101), the search module 120 will issue a notifying message to the user, for example by displaying a dialog box on the screen 12; and whereas if there is at least one match, the search module 120 will issue a search result displaying message to the search result displaying module 130.

The search result displaying module 130 is capable of responding to the search result displaying message from the above-mentioned search module 120 by displaying a prefix-matched word list 401 as shown in FIG. 2A on the screen 12 of the electronic data processing unit 10 to show every prefix-matched word retrieved by the search module 120 for user selection. In practical implementation, the prefix-matched word list 401 is for example displayed through a pop-up message box.

The word selection module 140 is capable of responding to a user-initiated word selecting event 320 (such as the user utilizes the mouse 13 to select a certain word 402 from the prefix-matched word list 401 as shown in FIG. 2B) by taking the user-selected word 402 as an input word to the electronic data processing unit 10.

The word-selection statistics recording module 210 is an optional module, which is capable of recording the number of times that each word in each prefix-matched word list 401 has been selected by the user, so that in each subsequent displaying of a certain prefix-matched word list 401, the words in that prefix-matched word list 401 are ordered accordingly. For example, as shown in FIG. 2A-2B, if in the first time of inputting the prefix [mis] 311, the user selects the word [misapplication] 402, then the word-selection statistics recording module 210 will record this event; and in the subsequent event that the user inputs the same prefix [mis] 311 again, the word-selection statistics recording module 210 will command the search result displaying module 130 to display the prefix-matched word list 401 in such a manner that the previously-selected word [misapplication] 402 is now placed at the topmost position of the prefix-matched word list 401 as shown in FIG. 2B. This feature allows the user to more quickly find his/her frequently-used word from the prefix-matched word list 401.

Referring to FIG. 1 together with FIGS. 2A-2B, in practical application, when the user utilizes the electronic data processing unit 10 to create a text-based electronic document through a word-input window 20 through the keyboard 11, it is assumed that the user wants to input the English word [misapplication] but the user forgets its complete spelling and remembers only the leading prefix part [mis]. In this case, the user needs just to utilize the keyboard 11 to input the character string of the prefix [mis] 311 through the word-input window 20 as shown in FIG. 2A and then press a certain key combination on the keyboard 11 to initiate a prefix-input event 310. In response, the prefix acquiring module 110 will take the user-input prefix [mis] 311 as a keyword and then issue a search enabling message to the search module 120, causing the search module 120 to respond by performing a search procedure on the word database 101 for every word in the word database 101 whose prefix is matched to the user-input prefix [mis] 311.

As the search procedure is completed, the search module 120 will issue a search result displaying message to the search result displaying module 130, causing the search result displaying module 130 to respond by displaying a prefix-matched word list 401 as shown in FIG. 2A on the screen 12 of the electronic data processing unit 10 that shows all prefix-matched words retrieved by the search module 120 from the word database 101. At this time, as shown in FIG. 2B, the user can utilize the mouse 13 or any other equivalent pointing device to select his/her desired word [misapplication] 402 from the prefix-matched word list 401. This action causes the occurrence of a user-initiated word selecting event 320, which causes the word selection module 140 to respond by taking the user-selected word [misapplication] 402 as an input word to the electronic data processing unit 10. This completes the input of the word [misapplication] to the electronic data processing unit 10.

In conclusion, the invention provides a prefix-indexed word-input aiding method and system which is designed for use in conjunction with an electronic data processing unit for providing the user with a prefix-indexed word-input aiding function that can aid the user in the input of words of a certain phonetic language into the electronic data processing unit more efficiently, i.e., the user needs just to input the prefix part of a certain word, and the invention will provides a list of all prefix-matched words on screen for the user to select his/her desired word. This feature can help the user to input words more quickly and efficiently. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A prefix-indexed word-input aiding method for use on an electronic data processing unit for providing a prefix-indexed word-input aiding function;
the prefix-indexed word-input aiding method comprising:
building a word database, which is used to prestore a selected vocabulary set of a particular phonetic language;
and in actual use,
responding to a user-initiated prefix-input event that inputs a prefix of a certain word to the electronic data processing unit by acquire the user-input prefix as a keyword;
searching through the word database for every word in the word database whose prefix is matched to the user-input prefix;
displaying a prefix-matched word list on the electronic data processing unit that shows every prefix-matched word retrieved by the search module from the word database; and
responding to a user-initiated word selecting event that selects a certain word from the prefix-matched word list by taking the user-selected word as an input word to the electronic data processing unit.

2. The prefix-indexed word-input aiding method of claim 1, wherein the electronic data processing unit is a desktop computer.

3. The prefix-indexed word-input aiding method of claim 1, wherein the electronic data processing unit is a notebook computer.

4. The prefix-indexed word-input aiding method of claim 1, wherein the electronic data processing unit is a tablet computer.

5. The prefix-indexed word-input aiding method of claim 1, wherein the electronic data processing unit is a network workstation.

6. The prefix-indexed word-input aiding method of claim 1, further comprising:
recording the number of times that each word in each prefix-matched word list has been selected, so that in each subsequent displaying of a certain prefix-matched word list, the words in that prefix-matched word list are ordered accordingly.

7. A prefix-indexed word-input aiding system for use with an electronic data processing unit for providing a prefix-indexed word-input aiding function;
the prefix-indexed word-input aiding system comprising:
a word database, which is used to prestore a selected vocabulary set of a particular phonetic language;
a prefix acquiring module, which is capable of responding to a user-initiated prefix-input event that inputs a prefix of a certain word to the electronic data processing unit by acquire the user-input prefix as a keyword;
a search module, which is capable of searching through the word database for every word in the word database whose prefix is matched to the user-input prefix;
a search result displaying module, which is capable of displaying a prefix-matched word list on the electronic data processing unit that shows every prefix-matched word retrieved by the search module from the word database; and
a word selection module, which is capable of responding to a user-initiated word selecting event that selects a certain word from the prefix-matched word list by taking the user-selected word as an input word to the electronic data processing unit.

8. The prefix-indexed word-input aiding system of claim 7, wherein the electronic data processing unit is a desktop computer.

9. The prefix-indexed word-input aiding system of claim 7, wherein the electronic data processing unit is a notebook computer.

10. The prefix-indexed word-input aiding system of claim 7, wherein the electronic data processing unit is a tablet computer.

11. The prefix-indexed word-input aiding system of claim 7, wherein the electronic data processing unit is a network workstation.

12. The prefix-indexed word-input aiding system of claim 7, further comprising:
a word-selection statistics recording module, which is capable of recording the number of times that each word in each prefix-matched word list has been selected, so that in each subsequent displaying of a certain prefix-matched word list, the words in that prefix-matched word list are ordered accordingly.

13. A prefix-indexed word-input aiding system for use with an electronic data processing unit for providing a prefix-indexed word-input aiding function;
the prefix-indexed word-input aiding system comprising:
a word database, which is used to prestore a selected vocabulary set of a particular phonetic language;
a prefix acquiring module, which is capable of responding to a user-initiated prefix-input event that inputs a prefix of a certain word to the electronic data processing unit by acquire the user-input prefix as a keyword;
a search module, which is capable of searching through the word database for every word in the word database whose prefix is matched to the user-input prefix;
a search result displaying module, which is capable of displaying a prefix-matched word list on the electronic data processing unit that shows every prefix-matched word retrieved by the search module from the word database;
a word selection module, which is capable of responding to a user-initiated word selecting event that selects a certain word from the prefix-matched word list by taking the user-selected word as an input word to the electronic data processing unit; and
a word-selection statistics recording module, which is capable of recording the number of times that each word in each prefix-matched word list has been selected, so that in each subsequent displaying of a certain prefix-matched word list, the words in that prefix-matched word list are ordered accordingly.

14. The prefix-indexed word-input aiding system of claim 13, wherein the electronic data processing unit is a desktop computer.

15. The prefix-indexed word-input aiding system of claim 13, wherein the electronic data processing unit is a notebook computer.

16. The prefix-indexed word-input aiding system of claim 13, wherein the electronic data processing unit is a tablet computer.

17. The prefix-indexed word-input aiding system of claim 13, wherein the electronic data processing unit is a network workstation.
